(19) United States
(12) Patent Application Publication
(10) Pub. No.: US 2006/0202964 A1
(43) Pub. Date: Sep. 14, 2006

(54) Intelligent modular server management system with enhanced graphical user interface

(76) Inventors: Yee Liaw, Warren, NJ (US); David Hoerl, Warren, NJ (US); Jayson Holovacs, Dunellen, NJ (US)

Correspondence Address: Ward & Olivo, 708 Third Avenue, New York, NY, 10017, US

(21) Appl. No.: 10/836,087

(22) Filed: May 3, 2004

(51) Int. Cl. G09G 5/00

(52) U.S. Cl. 345/168

(57) ABSTRACT

Disclosed is a remote computer or server management system for coupling a series of remote computers to one or more user workstations and providing an enhanced user interface for the selection, monitoring and control of a plurality of remote computers or servers by each workstation. Preferably, the user workstations include a keyboard, cursor control device, and video monitor through which a local user can select a remote computer for control through a central switch. The local workstation includes a general purpose processor programmed to display an enhanced graphical user interface (“GUI”) through which a local user can efficiently locate a remote computer for control. The GUI may also provide status indications for all servers, and may group the servers in an intelligent manner to aid the user in efficient location of the desired server.

### FIELD OF THE INVENTION

The present invention relates to a server management system for coupling a series of remote computers to one or more user workstations where an enhanced graphical user interface (GUI) is presented on the video monitor of each user workstation. In particular, the user workstation includes a keyboard, cursor control device, video monitor, and a general purpose processor to produce a GUI that allows a user to view, select, monitor and control any one of the series of remote computers.

### BACKGROUND OF THE INVENTION

A keyboard, video monitor, and mouse (“KVM”) switching system may be utilized to allow one or more user workstations to select and control any one of a plurality of remote computers via a central switching unit. Such systems are well known in the art and have been used by system administrators for at least ten years. Specifically, a KVM switching system allows a system user to control a remote computer using a local user workstation's keyboard, video monitor, and mouse as if these devices are directly connected to the computer. In this manner, a system user may access and control a plurality of remote computers, such as servers, from a single location (i.e., the location of the user workstation.

KVM switches are used in a typical computer environment. For example, a Local Area Network (LAN) allows for one or more computer servers to be connected to several computers such that the resources of each server are available to each of the connected computers. In such a system, a dedicated keyboard, video monitor and mouse may be employed for each computer and computer server.

To maintain proper operation of the LAN, the system administrator must maintain and monitor the individual computer servers and computers. This maintenance frequently requires the system administrator to perform numerous tasks from the user console located at the particular server or computer. For example, to reboot a computer or to add or delete files, the system administrator is often required to operate the server or computer from its local user console, which may be located at a substantial distance from the system administrator's computer. Therefore, to accomplish the task of system administration, the system administrator must often travel far distances to access the local user consoles of remotely located servers and computers. Alternatively, dedicated cables may be installed from each remotely located server and computer to the system administrator's user console to allow the system administrator to fully access and operate the remote computer equipment. However, such an alternative requires substantial wiring and wire harnessing, both of which may require additional cost. Additionally, as the distance between the system administrator's user console and the remote computer equipment increases, a decrease in the quality of the transmitted signal often results. Thus, dedicated cables between the system administrator's user console and remote computer equipment may not be a feasible alternative.

In addition to system administration, space is also an important concern for many computer networking environments, especially large-scale operations such as data-centers, server-farms, web-hosting facilities, and call-centers. These environments typically require space to house a keyboard, video monitor, and mouse for each piece of computer equipment in addition to all of the wiring required to connect and power these components. Furthermore, space is also required to house all of the network interface wiring. As more equipment is added to a computer network, it becomes more probable that the space required for the equipment and associated cabling will exceed the space allotted for the network. Therefore, network architecture, equipment size and available space are important issues when designing an effective computer network environment.

One method of reducing the amount of space required to house a computer network is to eliminate equipment and associated wiring (i.e., keyboard, video monitor, cursor control device, etc.) that is non-essential for proper operation of the computer network. This equipment, and associated wiring, may be eliminated if a system administrator is able to access the remote computers from one user console, thereby eliminating the dedicated equipment and the associated wiring for each remote computer. Elimination of this unnecessary equipment decreases the amount of space required for computer network environments.

As mentioned above, a KVM switching system allows a system user to control a remote computer using a local user workstation's keyboard, video monitor, and mouse as if these devices are directly connected to the remote computer. The system user may select a specific remote computer to access or control using any one of a variety of methods known in the art including selecting the remote computer from a list displayed on the user workstation's monitor using the user workstation's keyboard and/or mouse, selecting the computer from a list displayed on a switching system component's LCD or LED display, pressing one or more hot keys on the local user workstation's keyboard (e.g., F1, ALT-F1, F2, etc.), pushing a button on the face of a switching system component that corresponds with the desired remote computer, etc.

However, solutions for selecting a remote computer that are known in the art present problems in large-scale computer operations. For example, cycling through hundreds of computers utilizing only hot-keys can be time consuming and confusing for a user. A simple list of remote computers is also prohibitive if a user must scroll through hundreds of choices to find the desired computer. A need therefore exists for a more enhanced and intelligent user interface which displays available remote computers in an organized manner therefore allowing intelligent and efficient user interaction.

There are many KVM systems known in the art that facilitate extended range communications between a computer and a set of peripherals. For example, one such system is an intelligent, modular server management system for coupling a series of remote computers to one or more user stations, which allows for selective access of the remote computers. A centralized computer switching system enables a computer user station to access and operate a remote computer in a stable environment and transmit analog signals through the switching system over an extended range. The centralized computer switching system receives the input from the computer user station including the keyboard, video monitor and mouse signals and transmits the signals as though they were directly coupled to the remotely located computer terminal.

Another known system includes a connection for coupling a computer to a mouse, keyboard, and/or video monitor remotely located from the computer. The end of the connection that is coupled to the computer includes a first signal conditioner (i.e., a network of circuitry that dampens the ringing and reflections of the video signals and biases them to a selected voltage level) that conditions the keyboard, video monitor and mouse signals. Conditioning the video monitor signals includes reducing their amplitude in order to minimize the amount of “crosstalk” that is induced on the conductors adjacent to the video signal conductors during transmission of the video signals. This first signal conditioner is coupled to an extended range cable having a plurality of conductors that transmits the conditioned signals, power and logic ground potentials to a second signal conditioner (i.e., a network of circuitry that terminates and amplifies the video signals using a voltage divider), which restores the video signals to their original amplitude and outputs them to a video monitor.

A similar system, which enables two components to be located up to three hundred (300) feet apart, includes an encoder located at the computer end of the connection that receives analog red, green and blue signals from the computer and inputs each signal to a discrete current amplifier that modulates the signal current. Impedance matching networks then match the impedance of the red, green and blue signals to the impedance of the cable and transmit the signals to discrete emitter-follower transistors located at the video monitor end of the cable. These transistors amplify the signal prior to inputting the signal to the video monitor. Concurrently, the horizontal synchronization signal is input to a cable conductor and its impedance is not matched to the impedance of the cable, thereby allowing the conductor to attenuate the horizontal synchronization signal and reduce noise radiation.

Also known are systems for reducing the appearance of high frequency video noise in extended range communications. Such systems include an extended range communications link for transmitting transistor-transistor logic video signals from a local computer to a video monitor located up to a thousand feet (1,000) from the computer. The link includes a first signal conditioning circuit located at the computer end of the link for conditioning the received signals and transmitting them via the extended cable to a second signal conditioning circuit. The second signal conditioning circuit receives the transmitted video signals prior to inputting them to the video monitor.

Also known in the art are systems that enable a user to access a remote computer from a local user workstation where the local user workstation includes a keyboard, mouse, and or/video monitor. In one such system, a remote computer is selected from a menu displayed on a standard personal computer video monitor. Upon selection of a remote computer by the system user, the remote computer's video signals are transmitted to the local user workstation's video monitor. The system user may also control the remote computer utilizing the local user workstation's keyboard and monitor. This system is also capable of bi-directionally transmitting mouse and keyboard signals between the local user workstation and the remote computer. The remote computer and the local user workstation may be connected either via the Public Switched Telephone System (“PSTN”) and modems or via direct cabling.

A similar system includes a specific implementation of a computerized switching system for coupling a local user workstation, including a keyboard, mouse and/or video monitor, to one of a plurality of remote computers. In particular, the system includes a first signal conditioning unit that utilizes an on-screen display (OSD) processor as part of an on-screen programming circuit to display and control a menu of connected remote computers on the video monitor of the user workstation. The user may then select the desired computer from the list using the local user workstation's keyboard and/or mouse. To activate the menu, a user may press, for example, the “printscreen” key on the workstation's keyboard. This causes a superimposed video image generated by the on-screen programming circuit to appear on the workstation's video monitor. A user may then select a desired remote computer to control from this overlaid menu.

In such a system, in order to generate the overlaid menu on the video display, the on-screen programming circuit requires an OSD processor, an internal synchronization generator, an internal synchronization switch, an internal synchronization polarizer, overlay control logic, and at least two sets of tri-state buffers to couple the red, green, and blue components of the video signals received from the remote computer to the video monitor of the workstation, and to couple the output of the OSD processor to the leads that connect to the monitor's color inputs.

According to such a system, the on-screen programming circuit also must produce its own horizontal and vertical synchronization signals in order for the image to be displayed. To dictate which characters are displayed on the video monitor, the CPU sends instructional data to the OSD processor. This causes the processor to retrieve characters from an internal video RAM that are to be displayed on the workstation's video monitor.

Another known KVM switching system has on-screen display circuitry coupled to a user workstation for providing an interface to a keyboard, video monitor, mouse, and power (“KVMP”) switch. A first set of switching circuits coupled to a plurality of computers and the on-screen display circuit allows a user to access and control any of the computers using a keyboard, video monitor, and mouse attached to a user workstation. A second set of switching circuits coupled to the power supply of each computer and the on-screen display circuit allows a user to control the electrical power to each remote computer utilizing an on-screen display. To select a remote computer, a user activates the on-screen display by entering a hot key either with the keyboard and/or cursor control device. The on-screen display initially prompts a user to enter a username and password. Once the user has been verified, the user is provided a menu containing a list of all attached computers and a menu to control the power supply to each computer. The user utilizes the keyboard and/or cursor control device to select the desired remote computer or power settings from the on-screen display menu.

Of course there are many known variations on these systems. For example, similar known systems include increased modularity, where components of the system are “hot-swappable”. In such systems, the red, green and blue components of video signals are transmitted as analogue signals, whereas the horizontal and vertical synchronization signals are transmitted digitally. The systems utilize an analog crosspoint switch topology based on “switched transconductance architecture”. Such systems include dual redundant power supplies and upgradeable firmware thus enabling a highly scalable, modular design.

In view of the foregoing, a need clearly exists for a reliable, efficient, modular, remote computer management and switching system that allows information technology personnel to easily manage, and maintain a plurality of computers or servers. Such a system should include user workstations each with a keyboard, a video monitor and a cursor control device, where software implemented by a general purpose computer processor displays a graphical user interface (“GUI”) to the user. The GUI should allow the user to view, select, monitor and control the remote computers, servers, and other devices. Further, the GUI should optionally have the capability of providing identification information about the remote computers and logically organize and display available remote computers to the user. Such a system will aid in both small-scale computer centers and large-scale operations such as data-centers, server-farms, web-hosting facilities, and call-centers.

### SUMMARY OF THE INVENTION

The present invention relates to a server management system for coupling a series of remote computers to one or more user workstations allowing for efficient selection, monitoring and control of the remote devices, servers or other devices. For example, in one configuration, the system of the present invention includes multiple computer interface modules (“CIMs”) each coupled to the keyboard, video, and cursor control device ports of a remote computer or server. Each CIM preferably communicates via cabling to a central matrix switching unit (“MSU”), and in turn the MSU communicates via cabling to user station devices (“USTs”). Each UST is coupled to a local keyboard, video monitor and cursor control device. The present invention displays video from a remote computer on the local monitor, and allows a user to remotely access and control a remote computer from a plurality of remote computers using the local keyboard and cursor control device.

Preferably, the UST includes a general purpose central processing unit (CPU) that utilizes a standard operating system (e.g., Windows CE or Linux). Importantly, the general purpose CPU is used to perform the major control functions of the UST, including the display of an interactive GUI on the local video monitor to allow a user to view and select one of a plurality of remote devices. Having such a general purpose CPU generate the GUI has distinct advantages over the prior art. For example, it obviates the need for an on-screen display (OSD) processor, it enables the creation of a more user-friendly and intelligent interface, it has the ability to provide more information about servers than previous OSD chips, and the CPU can use existing operating systems (e.g., Windows CE, Linux, embedded Linux, etc.) to create an interface with a “look and feel” that is familiar to most users.

In accordance with the invention, a user interacts with the GUI to view information about the remote servers. The user also interacts with the GUI to choose a remote computer to monitor and/or control. The GUI according to the present invention provides an enhanced user interface such that the remote servers can be logically arranged and displayed to the user, and information about the available servers may be presented in any desirable manner. In one embodiment, the GUI includes an organized menu and list of servers, where the servers are grouped according to criteria which are meaningful to the user. The program implemented by the CPU of the UST preferably uses existing application programming interfaces (APIs) available as part of existing operating systems, thus enabling a user-friendly environment. For example, the program may be implemented in a Windows Corporate Edition (“CE”) or LINUX environment.

Additional features of the GUI enable the user to sort a list or sub-list of servers according to the server name, the status of the server, the server type, the server channel or address, the current user controlling the server, etc. The GUI also enables the user to search for a particular server with name-completion functionality. As described above, a feature of the present invention is that the GUI can restrict users to certain functionalities or to certain servers depending on the user's permissions. The GUI may also indicate which servers have problems so that a user can quickly search and access those servers. To aid a user in finding the desired server, the system of the present invention may include signaling circuitry for efficient location, error detection and/or general status indication of the remote computers or servers. An example of such circuitry is disclosed in co-pending patent application Ser. No. 10/667,132, which is hereby incorporated by reference in its entirety.

The UST preferably also includes methods for determining and verifying a user's identity. For example, the user may be required to provide an identification number, followed by a secret password associated with that identity. Of course, various identification techniques (e.g., biometric identification, RFID, etc.) can be utilized. Because the UST includes a general purpose CPU, the steps of verifying a user's identity are preferably implemented as part of the GUI. For example, the GUI may initially present a log-in screen to the user requiring the user to type-in a user name and password utilizing the local workstation's keyboard, or to submit to a biometric scan or identification, etc.

The enhanced features of the UST enable a user easily locate and select a remote device to monitor or control. Once a remote device is selected, the user may interact with that device using the local keyboard, cursor control device, and video monitor. Specifically, video signals from the remote device are transmitted to a CIM where they are encoded and transmitted to the MSU, e.g., through standard cabling, such as CAT-5 cabling. The MSU, in turn, transmits the encoded video data to the UST where it is decoded for display on the local user's video monitor.

The system also bi-directionally transmits keyboard and cursor control device data. When a user interacts with the peripheral devices connected to the UST, the keyboard and cursor control device generate signals that are received by the UST and transmitted to the MSU. The MSU interprets these signals and in turn generates new signals which are transmitted to the CIM. The CIM receives these signals and emulates keyboard and cursor control device signals which are sent to the keyboard and cursor control device ports of the selected remote computer.

Along with the video signals, keyboard and cursor control device signals are also sent from the CIM to the MSU. Specifically, the CIM receives keyboard and cursor control device signals from the remote device, and transmits these signals to the MSU. The MSU interprets the received signals and transmits them to the UST. Finally, the UST interprets the received signals and emulates keyboard and cursor control device signals that are sent to the local keyboard and cursor control device.

For example, suppose a local user depresses the “CAPS-LOCK” key. Initially, the local keyboard generates a signal that is received by the UST and transmitted to the MSU. The MSU interprets the received signal, identifies it as data for the CIM, and transmits the signal to the CIM associated with the selected remote computer. The CIM receives the signal from the MSU and emulates a keyboard signal that is sent to the keyboard port of the remote computer. The remote computer thus receives a signal indicative of a user depressing the CAPS-LOCK key.

In response, the remote computer generates a keyboard control signal that would, for example, illuminate the CAPS-LOCK light of a connected keyboard. This keyboard control signal is sent by the CIM to the MSU where it is interpreted and transmitted to the UST. The UST receives the signal and emulates a keyboard signal. This emulated signal is then output to the local keyboard, thus illuminating the CAPS-LOCK light.

Accordingly, the present invention provides full control of a server, computer or other device from a remote location. It may also be desirable to cycle the power of the server or computer in the event that all other methods of restarting the server fail. To this end, the present invention allows a local user to remotely control the power of a remote device. Preferably, this is accomplished through control of the power strip associated with the server. As is known in the art, power strips including serial-port communications are currently available. In the present invention, the CIM may connect and communicate with a server's power strip through such a serial connection. In addition, the GUI provided by the UST may provide the user with the ability to remotely access and control the power strip.

According to the preferred embodiment, to switch to a different remote computer, the user may enter a “hotkey” (or code) to instruct the UST to display the GUI containing a menu or list of remote devices. Alternatively, to enable a user to quickly switch to another computer, the present invention also allows for the user to enter specific codes to “toggle” between servers. In addition, the user may also use a mouse to quickly switch between computers. Thus a user may quickly and efficiently identify and select a remote computer to monitor and/or control.

The present system also provides compatibility between various operating systems and/or communication protocols. Preferably, the present system allows the same set of local peripheral devices to access, control, and locate remote computers executing a variety of operating systems and protocols, including but not limited to, those manufactured by Microsoft Corporation (Windows), Apple Computer, Inc. (Macintosh), Sun Microsystems, Inc. (Solaris), Digital Equipment Corporation, Compaq Computer Corporation (Alpha), International Business Machines (RS/6000), Hewlett-Packard Company (HP9000) and SGI (IRIX). In addition, local devices may communicate with remote computers via a variety of protocols including, but not limited to Universal Serial Bus (“USB”), PS/2, American Standard Code for Information Interchange (“ASCII”), Recommend Standard-232 (“RS-232”), and wireless.

A variety of cabling mechanisms may be used to connect the local user workstations and the remote computers to the computerized switching system of the present invention. Preferably, Category 5 Universal Twisted Pair (“CAT-5”) cable is used to connect each local UST (each having the necessary peripheral devices) and each remote CIM (each being connected to a remote computer) to the central switch (i.e., MSU) of the system. However, any type of cabling may be used without departing from the spirit of the present invention.

Therefore, it is an object of the present invention to provide a remote computer management system that displays a graphical user interface (GUI) on a local video monitor through which a user can efficiently select a remote computer for control using a local keyboard, and cursor control device.

It is another object of the invention to provide a GUI that is produced by a general purpose central processing unit so that the GUI is not limited to the rudimentary character-based output capabilities of an on-screen display (OSD) processor.

It is still another object of the invention to provide a GUI that enables a user to efficiently search and sort lists and groups of servers connected to the system so as to quickly find a desired computer for monitoring or control.

In addition, it is an object of the present invention to provide a GUI which displays detailed information about each remote device connected to the system.

It is still yet another object of the invention to provide a GUI that enables a user to view the status of select devices connected to the remote computer management system.

It is still another object of the invention to utilize a general purpose CPU to implement the GUI with a look and feel that resembles commercially available operating systems.

It is yet another object of the invention to allow information technology (IT) personnel to more efficiently manage a volume of servers for both small-scale and large-scale computer centers such as data-centers, server-farms, web-hosting facilities, call-centers, etc.

In addition, it is an object of the present invention to provide a remote computer management system that minimizes the space required to house the computers, peripheral devices and the overall computer management system.

Other objects, features, and characteristics of the present invention, as well as the methods of operation and functions of the related elements of the structure, and the combination of parts and economies of manufacture, will become more apparent upon consideration of the following detailed description with reference to the accompanying drawings, all of which form a part of this specification.

### BRIEF DESCRIPTION OF THE DRAWINGS

A further understanding of the present invention can be obtained by reference to a preferred embodiment set forth in the illustrations of the accompanying drawings. Although the illustrated embodiment is merely exemplary of systems for carrying out the present invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

For a more complete understanding of the present invention, reference is now made to the following drawings in which:

FIG. 1 depicts a schematic representation of a remote computer management switching system according to the preferred embodiment of the invention, including a user station (UST), a central switch (MSU) and a computer interface module (CIM).

FIG. 2A depicts a schematic representation of the preferred embodiment of the USTs shown in FIG. 1, illustrating its connection to the peripheral devices and it internal structure of the UST including the general purpose processor utilized by the UST to provide an enhanced GUI on the video monitor.

FIG. 2B shows a schematic representation of the automatic tuning circuit shown in the UST of FIG. 2A.

FIG. 3 shows a sample user interface screen generated by the GUI for display at the user workstation in accordance with the present invention.

FIG. 4 shows another sample user interface screen generated by the GUI for display on the user workstation in accordance with the present invention.

FIG. 5 depicts a schematic representation of the preferred embodiment of the MSU shown in FIG. 1 illustrating its ports and internal structure.

FIG. 6 depicts a schematic representation of the preferred embodiment of the CIMs shown in FIG. 1 illustrating its connection to remote devices and the MSU, as well as its internal structure including circuitry utilized for the remote location, alert and management features.

FIG. 7 is a diagram of a sample data packet that may be used to transmit data in the system according to the preferred embodiment of the invention.

FIG. 8 depicts a schematic representation of a remote computer management system according to an alternate embodiment of the present invention, illustrating connection of multiple user workstations and multiple remote computers via two MSUs.

FIG. 9 depicts a schematic representation of a remote computer management system in accordance with yet another alternate embodiment of the present invention, illustrating connection of multiple user workstations and multiple remote computers via more than two MSUs.

### DETAILED DESCRIPTION OF THE PREFERRED EMBODIMENTS

As required, a detailed illustrative embodiment of the present invention is disclosed herein. However, techniques, systems and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein, which define the scope of the present invention. The following presents a detailed description of the preferred embodiment (as well as some alternative embodiments) of the present invention.

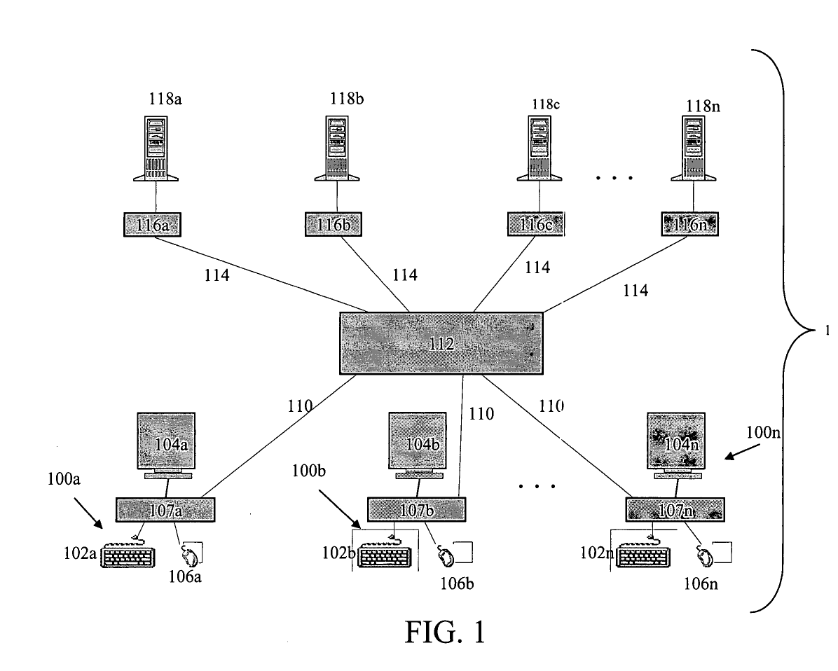

Referring first to FIG. 1, depicted is the architecture of the preferred computer management system in accordance with the present invention. Specifically, a modular, intelligent, computer management system is shown including a centrally located matrix switching unit (MSU) 112, multiple user stations (USTs) 107a-n, having attached keyboards 102a-n, video monitors 104a-n, and cursor control devices 106a-n, and multiple computer interface modules (CIMs) 116a-n each connected to a remote computer 118a-n. Each UST 107a-n and each CIM 116a-n is preferably connected to MSU 112 via cables 110 and 114, respectively, which are preferably Category 5 Universal Twisted Pair (CAT-5) cables. Alternatively, the invention may be used in a non-modular computer management or computer switching system.

Although single CAT-5 cabling is the preferred cabling for use with the present invention, other cabling may be used, such as coaxial, fiber optic or multiple CAT-5 cables, depending on the specific needs of the system user. CAT-5 cabling is preferred because it reduces cabling cost while maintaining the strength of signals that are transmitted over extended distances. Additionally, the use of single CAT-5 cabling minimizes the space required to house the computer system and its associated wiring. Alternatively, the cables described for use with the invention may be replaced with a form of wireless communications.

Individual CAT-5 cables may be used for connection of each UST 107a-n and each CIM 116a-n to MSU 112. Conventional CAT-5 cables include four (4) twisted pair of wires. The present invention utilizes three (3) of these twisted pair for the transmission of video signals. Each of the three (3) twisted pair transmits one of the three video color signals (i.e., red, green or blue). To allow all video signals to be transmitted via only three (3) twisted pair, the horizontal and vertical synchronization signals, which would otherwise each require their own twisted pair, are each individually encoded on one of the three color video signals. For example, the vertical synchronization signal may be encoded on the blue video signal while the horizontal synchronization signal may be encoded on the green video signal. All other non-video signals such as keyboard, cursor control device, and audio signals, are transmitted via the fourth twisted pair of wires.

Cables 110 and 114 are preferably connected to UST 107, MSU 112 and CIM 116 by plugging each end into a RJ-45 connector located on these respective components to be coupled by cables 110 and 114. Although RJ-45 connectors are preferred, other types of connectors may be used, including but not limited to RJ-11, RG-58, RG-59, British Naval Connector (“BNC”), ST connectors, or any other known type of connectors.

The remote computer management system includes local user workstations 100, each preferably comprising dedicated peripheral devices such as keyboard 102, video monitor 104 and/or cursor control device 106. Other peripheral devices may also be located at workstation 100, such as printers, scanners, video camera biometric scanning devices, microphones, etc. Each peripheral device is directly or indirectly connected to UST 107a-n, which is attached to MSU 112 via cable 110. USTs 107a-n preferably include USB and PS/2 ports to support connections of many peripheral devices. Of course, wireless peripheral devices may also be used with this system. During operation, all electronic signals received at a UST 107a-n from attached peripheral devices are transmitted to MSU 112 via cable 110. Thereafter, signals are transmitted to the desired CIM 116a-n via another cable 114. CIMs 116a-n, being coupled to remote computers 118a-n, interprets the received signals to emulate and transmit signals to the respective ports of the remote computer 118a-n.

Preferably, CIMs 116a-n is compatible with all commonly used, present day computer operating systems and protocols, including but not limited to those manufactured by Microsoft (Windows), Apple (Macintosh), Sun (Solaris), DEC, Compaq (Alpha), IBM (RS/6000), HP (HP9000) and SGI (IRIX). Additionally, local devices may communicate with remote computers via a variety of protocols including Universal Serial Bus (“USB”), American Standard Code for Information Interchange (“ASCII”) and Recommend Standard-232 (“RS-232”).

Remote computer management system 1 of the present invention may also be configured to connect varying quantities of user workstations 100a-n with varying quantities of remote computers 118a-n. Preferably, the system according to the present invention allows eight (8) USTs 107a-n and thirty-two (32) CIMs 116a-n to be connected via one MSU 112 while still achieving optimal signal transmission. If additional USTs or CIMs must be added, the system allows a plurality of MSUs 112 to be utilized to connect as many as sixty-four (64) user workstations 100 and ten thousand (10,000) remote computers 118a-n.

Selection of a remote computer 118a-n from a user workstation 100 may be accomplished with a variety of methods. One such method is choosing a remote computer 118a-n from a menu or list displayed on the screen of the user station's video monitor 104a-n. Preferably, the menu is generated by a CPU within the UST and is displayed as a GUI on the user station's video monitor 104a-n. A general purpose CPU within the UST implements an operating system such as Windows CE or LINUX thus enabling the GUI to be developed with standard APIs available as part of these operating systems. For example, if the CPU within the UST utilizes the Windows CE operating system, the GUI preferably has the same look and feel as other Windows CE programs, thus enabling interaction that is familiar to the user.

The utilization of a general purpose CPU enables the GUI to present an enhanced user interface. For example, in one embodiment, the GUI comprises a tree of remote servers, where the servers are logically arranged in sub-groups. A user navigates the tree, expanding sub-menus as necessary to find the desired remote server. The GUI can also display lists of servers, where the lists can be sorted by server name, server status, server type, etc.

Preferably, the servers are identified by names rather than by port number. The GUI can be configured to only display those servers authorized for access by the particular user. If a user selects a sub-menu, the available remote servers can be displayed in a more detailed fashion (e.g., as icons). If Windows CE is utilized as the operating system for the processor of the UST, the GUI may look substantially like Windows Explorer a web-browser or some other familiar navigational tools available thus providing a user-friendly interface.

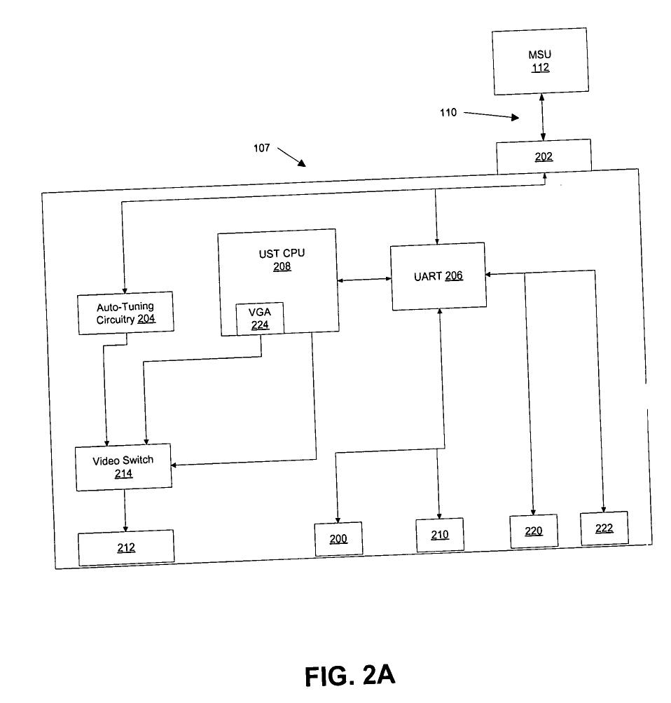

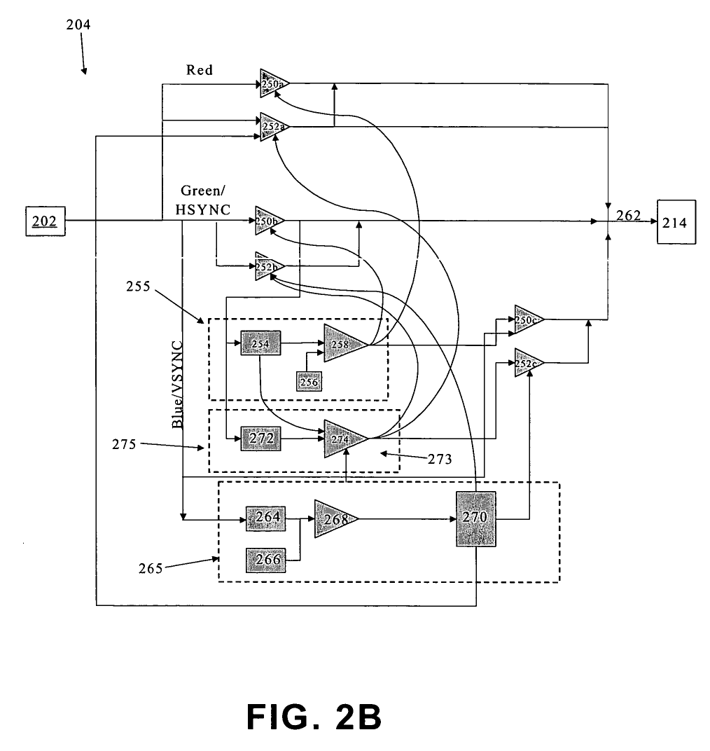

Turning next to FIG. 2A, depicted is a schematic diagram of the preferred internal structure of each UST 107 according to the present invention. As shown, UST 107 interfaces keyboard 102, video monitor 104, and cursor control device 106 with MSU 112 to enable a user to connect to any of a plurality of remote computers 118a-n (see FIG. 1). To accomplish this, each UST 107a-n preferably includes video port 212, USB ports 200 and 210, and PS/2 ports 220 and 222. If keyboard 102 and cursor control device 106 are USB compatible, then they are preferably connected to USB ports 200 and 210. However, if keyboard 102 and cursor control device 106 are PS/2 devices then they are connected to PS/2 ports 220 and 222. USB ports 200 and 210 can also be utilized for other USB devices (e.g., printers, scanners, biometric identification devices, etc.). Preferably, UST 107 is upgradeable through utilization of a USB flash disk, which interfaces with UST 107 through one of USB ports 200 and 210. Because both USB ports 200 and 210 and PS/2 ports 220 and 222 are capable of communicating data from keyboard 102 and cursor control device 106, it should be understood that UST 107 need not have all four (4) ports.

During operation, signals from keyboard 102 and cursor control device 106 generated at the local work station are received by UST CPU 208 from either ports 200 and 210 or 220 and 222 via UART 206. Data packets representing the keyboard and cursor control device information in the received signals are generated by UST CPU 208. The newly generated data packets are transmitted back to UART 206, whereupon they are converted to a serial format and transmitted through port 202 to MSU 112 via independent cable 110. It should be noted that the converted data packets may alternatively be transmitted via a wireless connection, thereby eliminating the need for cable 110.

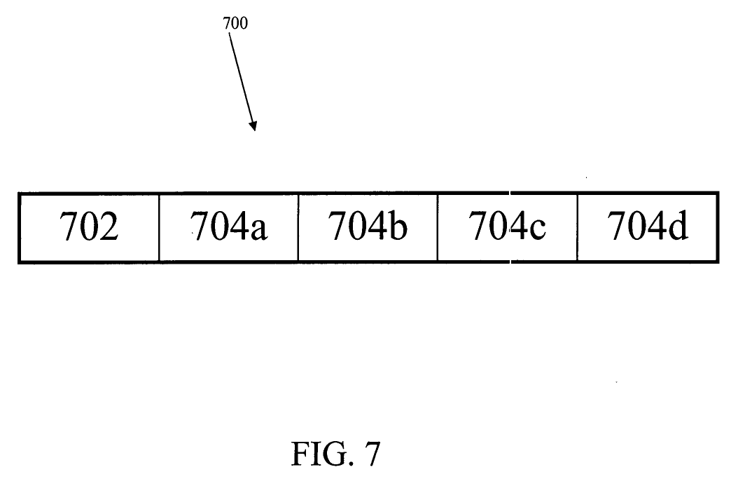

Referring to FIG. 7, provided is an example of a data packet that may be used to transmit keyboard and mouse information. In the example, protocol data packet 700 preferably consists of five bytes. First byte 702 comprises the instructional (or command) data as well as data regarding the total length of data packet 700. That is, the first half of first byte 702 contains the command data and the second half contains the length data. The subsequent four bytes 704a-d include the characters typed on keyboard 102 or clicks performed with cursor control device 106 (FIG. 1).

It is well known in the art to transmit command and length data in separate bytes. Therefore, utilizing conventional data packet technology, the data packet of the present invention would need to contain six bytes (i.e., one byte for command data, one byte for length data and four bytes for system data). In contrast, the preferred embodiment of the present invention minimizes the size of the data packet by combining the command and length data into one byte, thereby allowing four bytes of system data to be transmitted in a five-byte data packet. Consequently, signal transmission in the intelligent, modular server management system of the present invention is more efficient, allowing a single CAT-5 cable to be used for transmission of keyboard, mouse and video signals.

Conversely, keyboard and cursor control device signals received from the remote computer through MSU 112 via cable 110 (or wirelessly) are received via port 202. Thereafter, UART 206 de-serializes the serial data packet signals and transmits them to UST CPU 208. Alternatively, a non-UART device may be used to de-serialize the received serial data packets. UST CPU 208 then uses the information contained in the data packet signals to emulate keyboard and cursor control device signals. These emulated signals are applied to keyboard 102 and cursor control device 106 via USB Ports 200 and 210, PS/2 ports 220 and 222 or some combination thereof, depending on the type of keyboard 102 and cursor control device 106 being used.

Unidirectional video signals generated at the remote computer are also received at port 202 from MSU 112 via cable 110. However, these video signals are transmitted to tuning circuit 204, which conditions the video signals to a desired amplitude and frequency.

As shown in FIG. 2B, tuning circuit 204 preferably comprises red, green and blue variable gain amplifiers 250a-c, red, green and blue frequency compensation amplifiers 252a-c, slow peak detectors 254 and 264, voltage sources 256 and 266, comparators 258, 268 and 274, video switch 270, and fast peak detector 272.

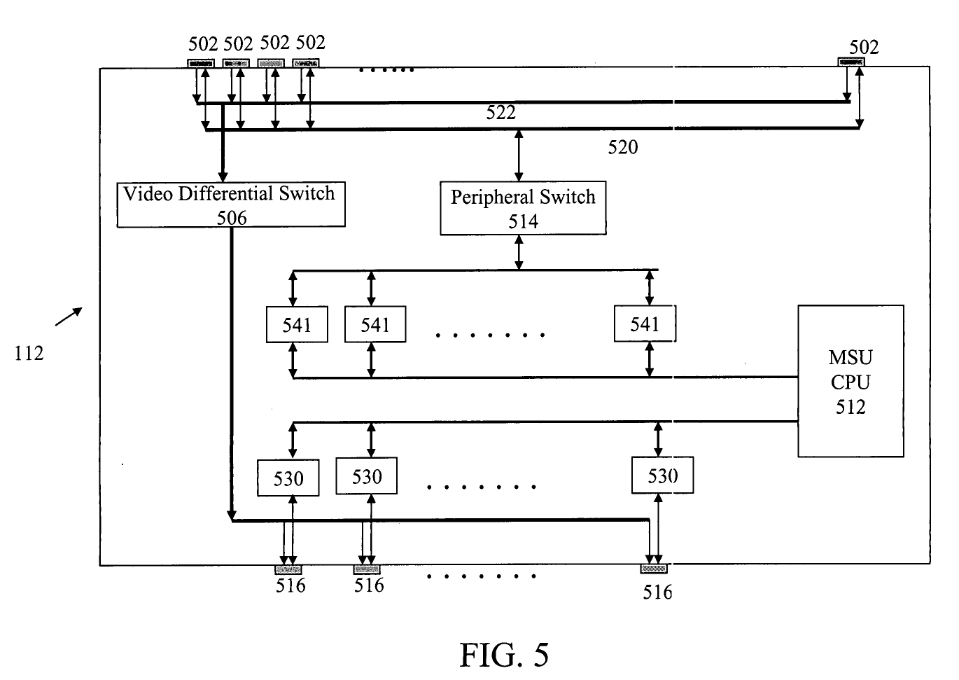

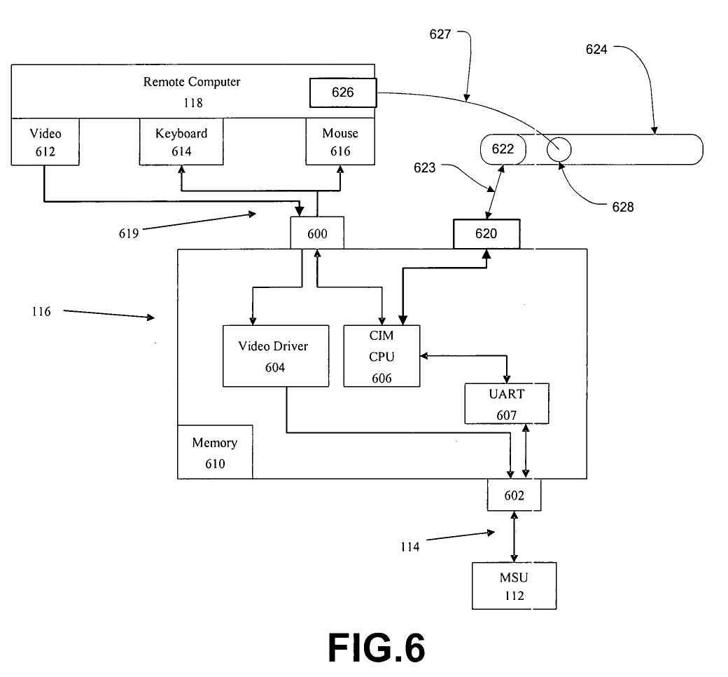

During operation of the system, the keyboard, video, and cursor control device signals from remote computer 118 are transmitted via cable 619 to CIM 116 (FIGS. 1 and 6). Thereafter, the video signals and data packets generated by CIM CPU 406 are transmitted from CIM 116 to MSU 112 via cable 114. At this point in the video signal transmission, the amplitudes of the transmitted video signals may be significantly reduced while the frequencies of the video signals may be attenuated. Subsequently, the video signals and the signals generated by MSU CPU 212 (FIG. 5) are transmitted from MSU 112 to UST 107, wherein the video signals are received by tuning circuit 204. Tuning circuit 204 is implemented to automatically tune the received signals to achieve a desired amplitude and frequency.

In the preferred embodiment, the horizontal and vertical synchronization signals are encoded on and transmitted with the green and blue video signals, respectively. However, the horizontal and vertical synchronization signals may be encoded on and transmitted with any one of the red, green, or blue video signals. Also, it is preferable that the horizontal and vertical synchronization signals are encoded as negative pulses, since the video signals (i.e., red, green, and blue) are typically positive pulses.

Tuning circuit 204 preferably contains dedicated circuitry for each of the red, blue, and green video color signals, a gain amplification adjustment circuit 255, a frequency compensation amplification adjustment circuit 275, and an additional filtering enablement circuit 265. The red component of the video signals is initially transmitted to red variable gain amplifier 250a and red variable frequency compensation amplifier 252a. Preferably, red variable gain amplifier 250a adjusts the amplitude of the red component of the video signals based upon the output of gain amplification adjustment circuit 255. Concurrently, red variable frequency compensation amplifier 252a adjusts the frequency of the red component of the video signals based upon the output of frequency compensation amplification adjustment circuit 275. The outputs of red variable gain amplification circuit 250a and red frequency compensation circuit 252a are electrically combined and transmitted via wire 262 to video port 212 via video switch 214 for transmission to video monitor 104.

The green component of the video signals, with the encoded horizontal synchronization signal, is initially transmitted to green variable gain amplifier 250b and green variable frequency compensation amplifier 252b. The two outputs are then added together and transmitted to gain amplification adjustment circuit 255 and frequency compensation amplification adjustment circuit 275. Gain amplification circuit 255 comprises slow peak detector 254 that receives the electrically combined outputs of green variable gain amplifier 250b and green variable frequency compensation amplifier 252b. Slow peak detector 254 detects the amplitude of the horizontal synchronization signal, which is encoded on the green component of the video signals, and transmits a signal representing this amplitude to comparators 258 and 274. Comparator 258 compares the signal received from slow peak detector 254 to a constant reference voltage supplied by voltage source 256. The signal supplied by voltage source 256 represents the desired amplitude for the horizontal synchronization signal. Next, comparator 258 transmits a signal to red variable gain amplifier 250a, green variable gain amplifier 250b, and blue variable gain amplifier 250c to adjust the level of amplification of the red, green, and blue components of the video signals until the desired amplitude is achieved.

Similarly, green variable frequency compensation amplifier 252b adjusts the level of amplification of the frequency of the horizontal synchronization signal based upon the output of frequency compensation amplification adjustment circuit 275. Circuit 275 preferably comprises fast peak detector 272 that also receives the electrically combined outputs of green variable gain amplifier 250b and green variable frequency compensation amplifier 252b. Fast peak detector 272 detects the rising edge of the horizontal synchronization signal and transmits a signal representing this rising edge to comparator 274. Then, comparator 274 compares the signal received from fast peak detector 272 to the output of slow peak detector 254 to compare the amplitude of the rising edge of the horizontal synchronization signal pulse to the amplitude of the horizontal synchronization signal pulse itself. Next, comparator 274 sends one or more signals that are output to red, green and blue variable frequency compensation amplifiers 252a-c to adjust the level of amplification of the red, green, and blue components of the video signals until the desired frequency is achieved. Optionally, the signal transmitted by comparator 274 may be manually adjusted using manual input 273 by a system administrator (e.g., using the option menu discussed above or controls located on the exterior of the UST). Such a feature would allow the system user to manually “tweak” the gain of the video signals until a desired video output is achieved.

The blue component of the video signals, along with the encoded vertical synchronization signal, is initially transmitted to blue variable gain amplification circuit 250c, blue variable frequency compensation circuit 252c, and filtering enablement circuit 265. Circuit 265 is employed to increase the range of red, green and blue variable frequency compensation amplifiers 252a-c when the video signals have been transmitted over approximately four hundred fifty (450) feet. The vertical synchronization signal, which is encoded on the blue component of the video signals as a square wave signal of known duration and amplitude, is used as a reference point for filtering enablement circuit 265. The blue component of the video signals and the encoded vertical synchronization signal are received by slow peak detector 264, which detects the amplitude of the vertical synchronization signal. Slow peak detector 264 transmits a signal representing the amplitude of the vertical synchronization signal to comparator 268, which compares it to the known amplitude of a similar signal transmitted four hundred fifty (450) feet. This known amplitude is represented by a constant reference voltage applied to comparator 268 by voltage source 266. If comparator 268 determines that the vertical synchronization signal (and therefore all of the video signals) has been transmitted over four hundred fifty (450) feet, a signal indicating this is transmitted to video switch 270. Video switch 270 then sends a signal to red, green and blue variable frequency compensation amplifiers 252a-c to increase the range of each frequency compensation amplifier 252a-c.

Subsequent to the amplification by gain amplification adjustment circuit 255 and the frequency compensation by frequency compensation amplification adjustment circuit 275, the conditioned red, green, and blue components of the video signals are transmitted to video switch 214. Thereafter, video switch 214 determines whether to transmit the video signals received from tuning circuit 204 (i.e., the video signals received from one of the remote computers 118) or the video signals received from UST CPU 208 to video port 212. Finally, the selected video signals are transmitted via port 212 for display on video monitor 104.

Optionally, UST 107 may incorporate circuitry to selectively compensate for the high-frequency attenuation that often occurs when signals are transmitted over extended distances. An example of such circuitry is disclosed in co-pending patent application Ser. No. 10/740,381, which is hereby incorporated by reference in its entirety. UST 107 may also incorporate skew compensation circuitry to compensate for the different pitch (and thus different cable length) of the twisted pair over which the red, green, and blue components of the video signal are transmitted. An example of such circuitry is disclosed in co-pending patent application Ser. No. 10/735,246, which is incorporated by reference in its entirety.

As described earlier, the utilization of a general purpose CPU (UST CPU 208) allows for the production of an enhanced option menu for display on video monitor 104. The option menu preferably comprises a graphical user interface (GUI) that enables a user to efficiently view lists of available remote computers. The GUI also enables a user to select a desired remote computer or server to monitor and control. Preferably, UST CPU 208 uses an operating system such as Windows Compact Edition (Windows CE) or LINUX. This enables UST CPU 208 to communicate with and to control all components of UST 107 (UART 206, video switch 214, and all I/O ports), while simultaneously producing an enhanced option menu. Video signals representative of this option menu are output from UST CPU 208 at video-out 224, which is coupled to video switch 214. Video switch 214 selects either video from video-out 224 or video from tuning circuit 204 for display on video monitor 104.

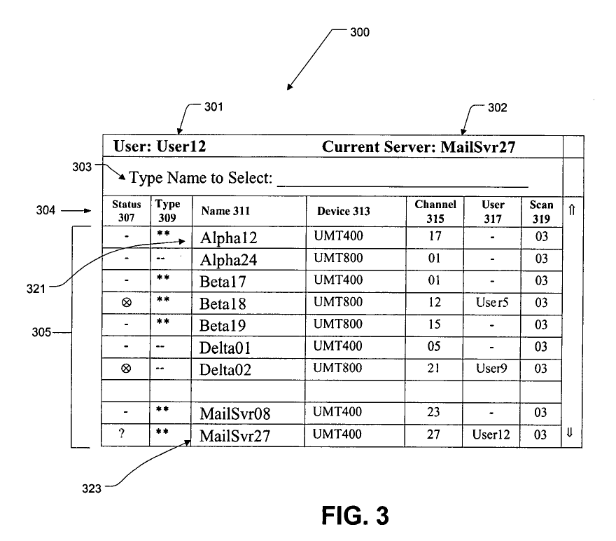

Turning next to FIG. 3, depicted is sample GUI menu 300 that may be produced by UST CPU 208. GUI menu 300 preferably consists of user field 301, current server field 302, select field 303, and sortable list 305. Sortable list 305 includes information about the remote computers and servers in a number of information fields 304. Each informational field 304 has a corresponding header, including, for example, status header 307, type header 309, name header 311, device header 313, channel header 315, user header 317, and scan header 319. Under each header is a row-entry for each remote server. For example, row-entry 321 indicates an entry for a server with name Alpha12, device UMT400 on channel number 17 and no current user. Row-entry 323 indicates that server with name MailSvr27, on channel number 27 is currently being controlled by User12.

GUI menu 300 offers a variety of user interaction. For example, by clicking on any of the headers, the list of servers is sorted by the identified field. If a user clicks (using cursor control device 106) on name header 311, the list of servers is sorted alphabetically by name. To select a particular remote server to control, a user may double-click on the corresponding row entry. For example, in FIG. 3, to select the remote server Alpha12, a user would double click row entry 321. Alternatively, a user can type the name “Alpha12” in select field 303.

Advantageously, GUI menu 300 enables a user to quickly find a computer to determine its status. GUI menu 300, with its search and sort capabilities, also enables a user to quickly identify which servers are currently in use, which servers are of a particular status, and which users are currently accessing other servers. In short, the GUI option menu of the present invention provides an efficient user interface through which a user can monitor, select, and operate any of a plurality of remote servers and computers.

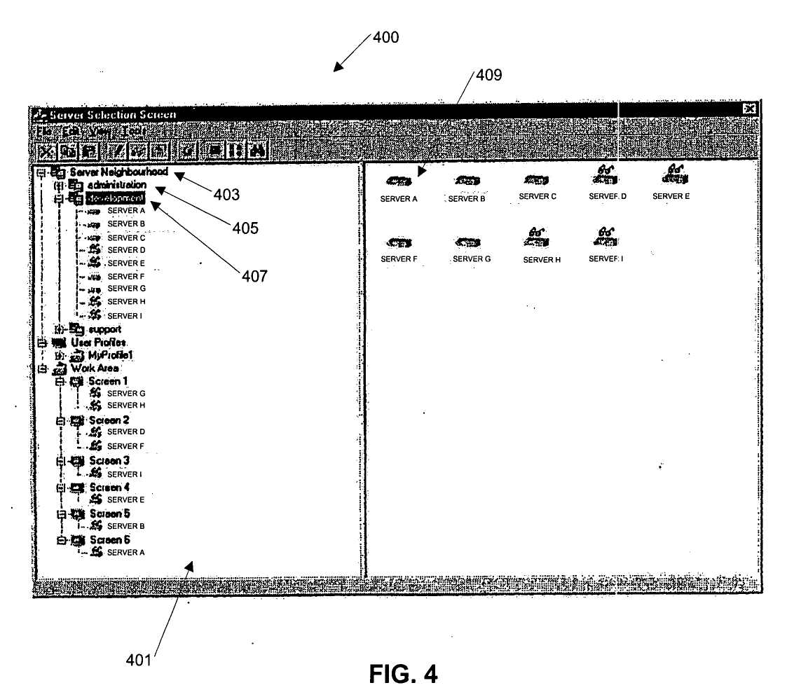

Turning next to FIG. 4, depicted is an alternative GUI menu 400 that may be generated by UST CPU 208 and displayed on local monitor 104. GUI menu 400 preferably includes tree window 401 and icon window 404. Tree window 401 includes tree 403, entitled “Server Neighborhood” as shown in FIG. 4, which includes sub-trees 405 and 407. Each of sub-trees 405 and 407 include lists of available servers. By clicking on a sub-tree (e.g., sub-tree 405), icons representing the available remote servers in that sub-group may be displayed in icon window 403. For example, icon 409 represents a server named “ServerA”. A user selects a remote computer to control, monitor, or operate by clicking on an icon in icon window 403 or a member of a sub-tree in tree window 401. GUI menu 400 thus enables a user to view available servers in a simple and organized fashion. Further, GUI menu 400 includes a graphical representation of available remote servers which may provide a user with detailed information regarding the remote computers including status, name, network group, IP address, operating system, etc. as well as enable a user to select a remote computer to monitor and/or control.

Turning next to FIG. 5, depicted is a schematic representation of the preferred embodiment of MSU 112. According to the invention, MSU 112 enables multiple users to access and operate any of a plurality of remote computers 118 from any of a plurality of workstations 100 (see FIG. 1). Access by a user to one of remote computers 118 from one of local user workstations 100 is performed completely via one or more MSUs 112, independent of any network that may couple the remote computers to each other such as a Local Area Network, Wide Area Network, etc. In other words, computer management system 1 according to the present invention does not require an existing computer network to allow a local user workstation 100 to control remote computers 118. Rather, all physical connections between local user workstations 100 and remote computers 118 occur through MSU 112.

In the preferred embodiment, MSU 112 comprises a plurality of CIM ports 502 that are preferably RJ-45 sockets, which allow each CIM 116 to be connected to MSU 112 via an independent cable 114 (FIG. 1). The uni-directionally transmitted (i.e., from the remote computer to the user workstation only) video signals are received from remote server 118 at MSU 112 through CIM ports 502 onto video bus 522, whereupon the video signals are transmitted to video differential switch 506. Video differential switch 506 is capable of transmitting any video signals received from video bus 522 to any UST port 516. The transmitted video signals are then transmitted via independent cable 110 to attached UST 107 (FIG. 1).

In addition to transmitting the unidirectional video signals, MSU 112 bi-directionally transmits keyboard and mouse signals between USTs 107a-n and CIMs 116a-n (FIG. 1). When transmitting the keyboard and mouse signals from one of CIMs 116 to one of USTs 107a-n, these signals are received through CIM ports 502 on peripheral bus 520, whereupon they are transmitted to peripheral switch 514. Thereafter, peripheral switch 514 transmits these signals to the appropriate CIM UART 541, which de-serializes the signals (i.e., converts the signals from a serial format to a format that is compatible with MSU CPU 112, e.g., parallel format) and transmits them to MSU CPU 512. MSU CPU 512 analyzes the received signals and generates a new data packet based upon command information contained within the received signals. This new data packet is transmitted to the appropriate UST UART 530, which serializes the signals and transmits them to the appropriate UST port 516 for transmission via independent cable 110 to the appropriate UST 107a-n (FIG. 1).

Conversely, MSU 112 also transmits keyboard and mouse signals received from a workstation 100a-n at one UST 107a-n to a CIM 116a-n connected to a selected remote computer 118a-n (FIG. 1). In this aspect, the keyboard and mouse signals are received at UST 107 and transmitted to the respective UST port 516 located at MSU 112. Thereafter, these signals are transmitted to UST UART 530, which de-serializes the signals and transmits them as data packets to MSU CPU 512. MSU CPU 512 interprets the information contained in the data packets of the received signals to create new (or emulated) signals, which also represent newly generated data packets. These new signals are then transmitted to the CIM UART 541 (see FIG. 6) that is associated with the desired remote computer 118. CIM UART 541 serializes the signals and transmits them to peripheral switch 514, which transmits the signals to the desired CIM port 502 via peripheral bus 520. Subsequently, the keyboard and mouse signals are transmitted to the appropriate CIM 116, which is connected to the desired remote computer 118 (FIG. 1).

Turning next to FIG. 6, shown is a schematic representation of the preferred embodiment of each CIM 116a-n. Initially, each CIM 116a-n may be configured to be compatible with any known computer system, including but not limited to those manufactured by Microsoft (Windows), Apple (Macintosh), Sun (Unix), DEC, Compaq (Alpha), IBM (RS/6000), HP (HP9000) and SGI. However, it is foreseeable that the technology of the present invention will also be compatible with those computer systems not yet contemplated.

CIM 116 serves as the interface circuit connecting remote computer 118 with MSU 112. Specifically, CIM 116 interfaces video port 612, keyboard port 614 and cursor control device port 616 of remote computer 118 to MSU 112 (e.g., via CAT-5 cable 618 and port 600, or wirelessly). Video signals are uni-directionally transmitted from remote computer 118 to MSU 112 through CIM 116. However, as discussed previously, keyboard and cursor control device signals may be transmitted bi-directionally between remote computer 118 and MSU 112.

During operation, video signals are transmitted from video port 612 of remote computer 118 to port 600 of CIM 116 via direct connection 619. From port 600, the unidirectional video signals are transmitted to video driver 604, which converts the standard red, green and blue video signals to a differential signal for transmission through port 602 to MSU 112 via cable 114. Each color signal is transmitted via its own twisted pair of wires contained within cable 114 (when transmitted from CIM 116 to MSU 112) or cable 110 (when transmitted from MSU 112 to UST 107)(FIG. 1). Furthermore, video driver 604 appends the horizontal and vertical synchronization signals to one of the red, green or blue video signals to allow all five components of the video signals to be transmitted via only three twisted pair of wires of cables 110 or 114. That is, the horizontal and vertical synchronization signals are each transmitted on its own color signal.

Keyboard and cursor control device signals generated at remote computer 118 are received by CIM CPU 606 from keyboard port 614 and cursor control device port 616, respectively, via cable 618 and port 600. Data packets representing the keyboard and cursor control device information in the received signals are generated by CIM CPU 606. The newly generated data packets are transmitted to UART 608, which serializes the signals and transmits them via cable 114 to MSU 112 through port 602.

Keyboard and cursor control device signals received from the local user workstation through MSU 112 and connection 114 (FIG. 1) are received at port 602. Alternatively, the received data packet signals may be de-serialized by a non-UART device. CIM CPU 606 uses the information contained in the data packet signals to emulate keyboard and mouse signals. These emulated signals are applied to keyboard port 614 and mouse port 616 through port 600 via connection 618.

Furthermore, CIM 116 preferably contains memory unit 610 to store identification information for CIM 116 and the connected remote computer 118, including information such as its assigned name, group, address, etc. Thus, if a specific remote computer 118 is not functioning properly, it is easy to identify which remote computer 118 has malfunctioned. In addition, the address of each CIM 116 facilitates proper transmission of the keyboard and mouse signals since such address is included in the keyboard and mouse data packets generated by MSU CPU 212. For example, if CIM 116 receives a data packet containing an address other than its own address, the data packet will be returned to MSU CPU 212 for retransmission to the proper CIM 116. Furthermore, memory unit 610 allows CIM 116 and its connected remote computer 118 to be easily identified even if it is relocated and/or connected to a new MSU 112 or a new port of the same MSU 112. Upon reconnection of CIM 116, MSU 112 reads the identification information stored in memory unit 610. This information allows MSU 112 to reconfigure or update the location of CIM 116, which ensures that the system continues to properly route information to CIM 116 and connect the appropriate workstation 100a-n to the desired remote computers 118a-n. This feature allows system administrators to easily re-organize CIMs 116a-n and remote computers 118a-n without re-programming computer management system 1.

CIM 116 may also contain circuitry to aid a system administrator in locating a remote server if the remote server has a problem. Such circuitry, disclosed in co-pending patent application Ser. No. 10/667,132, which is incorporated by reference, is especially useful in large scale operations such as server-farms, web-clusters, etc.

Finally, in the preferred embodiment of the present invention, CIM 116 may control the power of its connected remote computer 118. Specifically, CIM CPU 606 communicates serial data to serial port 620, which in turn communicates serially with serial port 622 of power-strip 624 through connection 623. Remote computer 118 receives power through power connection 626 over power cable 627 from outlet 628 of power-strip 624. As is known in the art, power-strip 624 can be controlled with instructions transmitted through serial port 622. As described earlier, UST 107 provides a GUI menu that includes options for a user to cycle the power of a server under the user's control. If the user chooses to cycle the power, data sent through MSU 112 to CIM 116 will indicate that the power source of remote computer 118 should cycled. CIM CPU 606 provides the appropriate instruction serially to serial port 622 of power-strip 624, which then cycles the power of remote computer 118 through outlet 628. This may also be performed wirelessly, as discussed above regarding UST 107 and CIM 116.

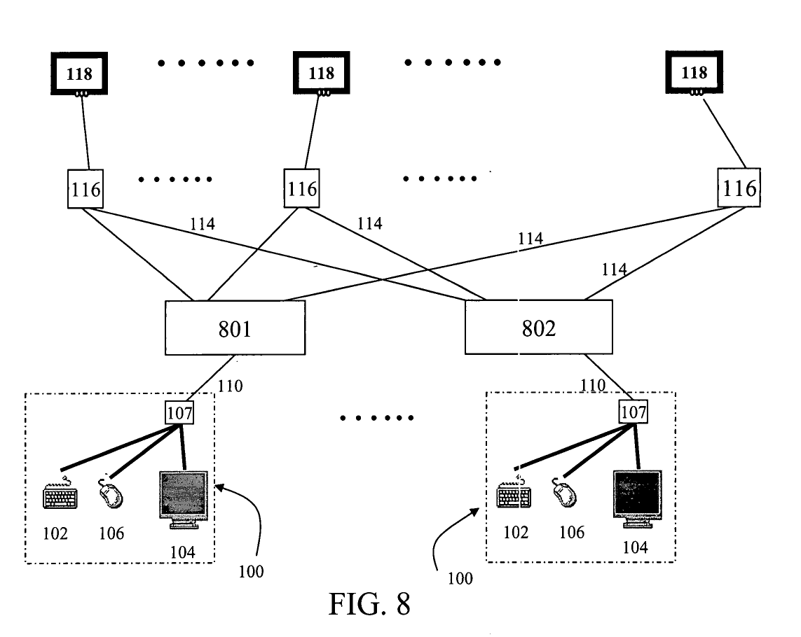

Referring next to FIG. 8, shown is an alternate embodiment of the intelligent, modular computer management system of the present invention in which the system is expanded to include two MSUs 801, 802, each having eight (8) inputs and thirty-two (32) outputs. This configuration allows connection of sixteen (16) workstations 100 to access and operate thirty-two (32) remote computers 118. In this alternate embodiment, each UST 107 of workstation 100 may be linked to either first MSU 801 or second MSU 802 via cable 110. All signals received at UST 107 are transmitted via its connected MSU (e.g., first MSU 801 or second MSU 802) to CIM 116 that is connected to the desired remote computer 118. In this alternate embodiment, each CIM 116 provides an interface for both first MSU 801 and second MSU 802 to remote computers 118 via two (2) single CAT-5 cables 114 or wirelessly. Thus, CIM 116 allows the sixteen (16) user workstations 100 to operate thirty-two (32) remote computers 118. In addition, this embodiment allows two (2) separate user workstations 100 to simultaneously access and operate the same remote computer 118, each connecting through a separate MSU (either 801 or 802). This embodiment also allows a first user workstation 100 to inform a second user workstation 100 that a remote computer 118 is in use and, therefore, access to it may be restricted.

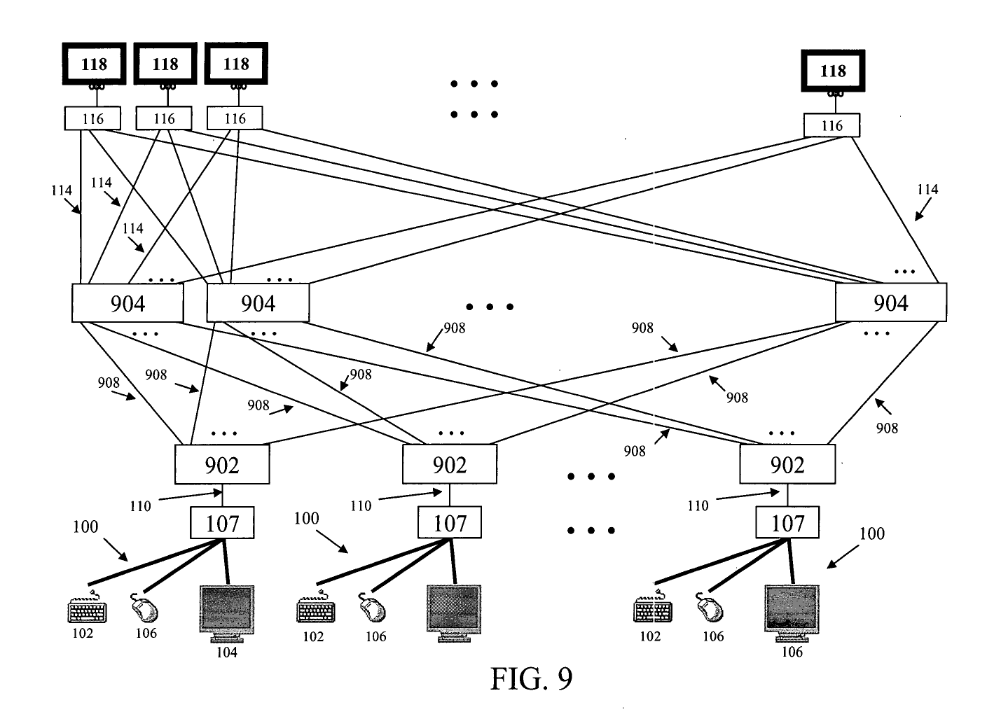

Referring finally to FIG. 9, shown is yet another alternate embodiment of the intelligent, modular server system of the present invention. In this configuration, the use of up to forty (40) total MSUs (i.e., up to eight (8) first tier MSUs 902 and up to thirty-two (32) second tier MSUs 904), wherein each first tier MSU 902 and second tier MSU 904 has eight (8) inputs and thirty-two (32) outputs, allows up to sixty-four (64) user workstations 100 to operate and up to access one thousand twenty four (1,024) different remote computers 118. In this alternate embodiment, up to eight USTs 107 may be directly linked to each of eight (8) first tier MSUs 902 via connections 110. First tier MSU 902 routes all signals received from user workstation 100 via connection 908 to one of up to thirty-two second tier MSUs 904 each connected to up to thirty-two CIMs 116 each associated with a different remote computer 118. Second tier MSU 904 routes the received signals to the respective CIM 116 via connection 114, whereupon CIM 116 applies these signals to the respective ports of remote computer 118. In this embodiment, the second tier of MSUs 904 preferably comprises thirty-two (32) units. Each second tier MSU 904 is coupled to multiple CIMs 116, which provide a direct interface to each of the one thousand twenty four (1,024) potential remote computers 118 via connections 114.

Although FIG. 9 depicts a configuration used to access and control one thousand twenty four (1,024) remote computers 118 from sixty-four (64) user workstations 100, many other system configurations are available to allow a greater number of user workstations 100 to be connected to a greater number of remote computers 118. For example, the number of MSU tiers may be increased, or, alternatively, hubs may be incorporated. Also, the MSUs 112 may be designed to include more than eight (8) inputs and more than thirty-two (32) outputs to significantly increase the number of user workstations 100 and remote computers that may be connected.

While the present invention has been described with reference to the preferred embodiments and several alternative embodiments, which embodiments have been set forth in considerable detail for the purposes of making a complete disclosure of the invention, such embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention. It should be appreciated that the present invention is capable of being embodied in other forms without departing from its essential characteristics.

1. A computer management system comprising:
one or more user workstation devices each including a video monitor and at least one of a keyboard and a cursor control device;
a processor disposed in each of said user workstation devices for generating an option menu on said video monitor and for receiving first data from at least one of said keyboard and said cursor control device; one or more computer interface devices each coupled to a remote computer; and
a switch in communication with both of said user workstation devices and said computer interface devices, said switch for receiving said data from one of said user workstation devices and supplying second data to a selected one of said computer interface devices;
wherein said selected one of said computer interface devices provides said second data to said coupled remote computer, and wherein said second data is an emulated form of said first data.

2. A system according to claim 1, wherein said processor is a general purpose microprocessor.

3. A system according to claim 1, wherein said option menu comprises a graphical user interface (GUI).

4. A system according to claim 1, wherein said option menu comprises multiple sub-windows.

5. A system according to claim 4, wherein one of said sub-windows comprises a log-in means.

6. A system according to claim 5, wherein said log-in means includes a user identification field.

7. A system according to claim 5, wherein said log-in means requires biometric identification from a user, said biometric identification selected from the group consisting of retinal scan, fingerprints, and voiceprints.

8. A system according to claim 4, wherein one of said sub-windows comprises a list of said remote computers.

9. A system according to claim 8, wherein said list includes clickable identification means such that said remote computers can be selected for operation by clicking thereon.

10. A system according to claim 8, wherein clicking on said identification means displays detailed information relating to said remote computers.

11. A system according to claim 10, wherein said list is sortable according to one or more items in said detailed information.

12. A system according to claim 8, wherein said list is searchable.

13. A system according to claim 8, wherein said list is expandable to display said detailed information of said remote computers.

14. A system according to claim 8, wherein said identification means is an icon.

15. A system according to claim 1, wherein said option menu comprises a plurality of fields.

16. A system according to claim 15, wherein one of said fields is a user field for displaying a user name.

17. A system according to claim 16, wherein one of said remote computers can be selected for operation by clicking on one of said user names in said user field.

18. A system according to claim 15, wherein one of said fields is a server field for displaying a name of one of said remote computers.

19. A system according to claim 15, wherein one of said fields is a identification field for storing an identifier of said remote computers.

20. A system according to claim 15, wherein said fields are sortable.

21. A system according to claim 15, wherein said fields are sortable by clicking on a header in said fields.

22. A system according to claim 1, wherein said processor includes an operating system.

23. A system according to claim 22, wherein said operating system is selected from the group consisting of Linux, Windows, Windows Compact Edition, Macintosh, and Pocket PC.

24. A system according to claim 1, wherein said option menu is displayed on said video monitor in response to predefined keyboard signals.

25. A system according to claim 1, wherein said option menu is interactive using at least one of said keyboard and said cursor control device.

26. A remote device management system comprising:
a user workstation coupled to a video monitor and at least one of a keyboard and cursor control device, said user workstation including a general purpose processor for generating an option menu for display on said video monitor;
a plurality of interface devices each coupled to a remote device; and
a switch unit disposed between said user workstation and said plurality of remote interface devices for receiving signals from said user workstation, for emulating said signals and supplying said emulated signals to said remote interface devices, and for receiving video signals from any of said remote devices through said interface devices and transmitting said video signals to said user workstation for display on said video monitor;
wherein said option menu displays information associated with said remote devices to enable selection and control of any one of said remote device.

27. A system according to claim 26, wherein said option menu comprises a graphical user interface.

28. A system according to claim 26, wherein said option menu includes a log-in means.

29. A system according to claim 28, wherein said log-in means includes a user identification field.

30. A system according to claim 28, wherein said log-in means requires biometric identification from a user, said biometric identification selected from the group consisting of retinal scan, fingerprints, and voiceprints.

31. A system according to claim 26, wherein said option menu comprises icons representative of said remote device.

32. A system according to claim 26, wherein said options menu includes a list of said remote devices.

33. A system according to claim 32, wherein said list is expandable to display detailed information relating to said remote devices.

34. A system according to claim 32, wherein said list is comprised comprises a list of said remote devices.

35. A system according to claim 26, wherein said general purpose processor receives keyboard and cursor control device signals from said keyboard and cursor control device and transmits said signals to said switch.

36. A system according to claim 26, wherein said options menu comprises multiple sub-windows.

37. A system according to claim 36, wherein one of said sub-windows comprises a list of said remote devices.

38. A system according to claim 45, wherein one of said sub-windows comprises icons representative of said remote devices.

38. A system according to claim 26, wherein said options menu comprises a menu bar.

39. A system according to claim 38, wherein said menu bar comprises menu items selected from an identification group.

40. A method of selecting any of a plurality of remote devices for control, said method comprising the steps of:
generating a graphical user interface for display on a video monitor;
receiving keyboard and cursor control device signals from a keyboard or a cursor control device connected to a user interface device indicative of selecting a remote device displayed by said graphical user interface; and
transmitting a control signal to a central switch in response to said keyboard and cursor control device signals;
wherein said central switch establishes a means for communicating keyboard signals or said cursor control device, and video signals between said user interface device and any of said plurality of remote devices in response to said control signal.

41. A method according to claim 40, wherein said generating is implemented by a general purpose processor.

42. A method according to claim 41, wherein said general purpose processor includes an operating system.

43. A system according to claim 42, wherein said operating system is selected from the group consisting of Linux, Windows, Windows Compact Edition, Macintosh, and pocket PC.

44. A method according to claim 41, wherein said transmitting is implemented by said general purpose processor.

45. A method according to claim 40, wherein said generating is implemented in response to predefined keyboard and/or cursor control device signals.

46. A method according to claim 40, wherein said graphical user interface comprises multiple sub-windows.

47. A method according to claim 46, wherein one of said sub-windows comprises a log-in means.

48. A method according to claim 47, wherein said log-in means includes a user identification field.

49. A method according to claim 47, wherein said log-in means requires biometric identification from a user, said biometric identification selected from the group consisting of retinal scan, fingerprints, and voiceprints.

50. A method according to claim 46, wherein one of said sub-windows comprises a list of said remote devices.

51. A method according to claim 50, wherein said list includes clickable identification means such that one of said remote devices can be selected for operation by clicking thereon.

52. A method according to claim 50, wherein clicking on said identification means displays detailed information relating to said remote devices.

53. A system according to claim 50, wherein said list is searchable.

54. A system according to claim 50, wherein said list is sortable according to one or more items in said detailed information.

55. A system according to claim 51, wherein said list is expandable to display detailed information relating to said remote devices.

56. A system according to claim 56, wherein said identification means is an icon.

57. A method according to claim 40, wherein said graphical user interface comprises a plurality of fields.

58. A method according to claim 57, wherein one of said fields is a user field for displaying a user name.

59. A method according to claim 58, wherein a said remote device can be selected for operation by clicking on one of said user names in said user field.

60. A method according to claim 57, wherein one of said fields is a server field for displaying a name of one of said remote devices.

61. A method according to claim 57, wherein one of said fields is a select field for enabling a user to input a name of one of said remote devices.

62. A method according to claim 57, wherein said fields are sortable.

63. A method according to claim 60, wherein said fields are sortable by clicking on a header in said fields.

64. A method according to claim 40, wherein said means for communicating includes receiving keyboard and cursor control device signals from said keyboard or said cursor control device connected to said workstation, and generating emulated signals and transmits said emulated signals to said remote device.
